(19) United States
(12) Patent Application Publication
(10) Pub. No.: US 2013/0117684 A1
(43) Pub. Date: May 9, 2013

(54) DYNAMICALLY GENERATED ICONS FOR GRAPHICAL USER INTERFACE ON CLIENT

(71) Applicants: Harshal Ingole, San Jose, CA (US); Ankit Prasad, Palo Alto, CA (US); Jeremy Brian Leland, Mountain View, CA (US); Nina Gholami, San Jose, CA (US)

(72) Inventors: Harshal Ingole, San Jose, CA (US); Ankit Prasad, Palo Alto, CA (US); Jeremy Brian Leland, Mountain View, CA (US); Nina Gholami, San Jose, CA (US)

(73) Assignee: MICROSOFT CORPORATION, Redmond, WA (US)

(21) Appl. No.: 13/288,810

(22) Filed: Nov. 3, 2011

(51) Int. Cl. G06F 3/01

(52) U.S. Cl. 715/744

(57) ABSTRACT

Icons for use and display in a graphical user interface (GUI) on a client are generated on a server. The icons (e.g. bitmaps, PNG, GIF, JPEG . . . ) that may be used in the GUI are created by the server and reflect a theme that is associated with a document. The icons used in the GUI may contain advanced graphical effects (e.g. shadows, gradients, reflections, glows, 3D perspectives, and the like) that may not be able to be generated by the client. The icons may be rendered automatically (e.g. during initial processing of a theme for a document, in response to an action) and/or upon demand. The icons are grouped by the server and information about the individual icons is saved as metadata. The client receives the grouped icons and corresponding metadata and accesses the icons to create a display of GUI elements such as galleries, buttons, and dialogs.

### BACKGROUND

Themes may be used to modify the appearance of documents. A theme is a set of unified design elements the provides a look for the document by using color, fonts and graphics. Themes may be applied to documents not only within one program but across multiple programs. Some themes may contain effects such as shadows, gradients, 3D perspectives, and the like that may utilize advance graphic operations.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Icons for use and display in a graphical user interface (GUI) on a client are generated on a server. The icons (e.g. bitmaps, PNG, GIF, JPEG . . . ) that may be used in the GUI are created by the server and reflect a theme that is associated with a document. The icons used in the GUI may contain advanced graphical effects (e.g. shadows, gradients, reflections, glows, 3D perspectives, and the like) that may not be able to be generated by the client. The icons may be rendered automatically (e.g. during initial processing of a theme for a document, in response to an action) and/or upon demand. The icons are grouped by the server and information about the individual icons, such as the layout and/or style each icon represents, how/when to display the icon, as well as its position in the group, is saved as metadata. This metadata is included with the grouping of icons that is provided by the server to the client. The client receives the grouped icons and corresponding metadata and accesses the icons to create a display of GUI elements such as galleries, buttons, and dialogs.

### BRIEF DESCRIPTION OF THE DRAWINGS

FIG. 1 illustrates an exemplary computing device;

FIG. 2 illustrates an exemplary system for using server-side generated icons within a client GUI;

FIG. 3 shows a system using server-side processing for generating icons displayed on a client GUI;

FIG. 4 shows a process for dynamically generating icons and metadata on a server for client GUI elements;

FIG. 5 illustrates a process for updating a GUI using dynamically generated icons and metadata;

FIG. 6 shows exemplary displays of a presentation that shows a gallery UI on a client display using icons generated on a server for a first theme and a second theme;

FIG. 7 shows exemplary icons groupings created on a server for a first theme and a second theme; and

FIG. 8 illustrates a system architecture for dynamically generating icons on a server for a graphical user interface on a client.

### DETAILED DESCRIPTION

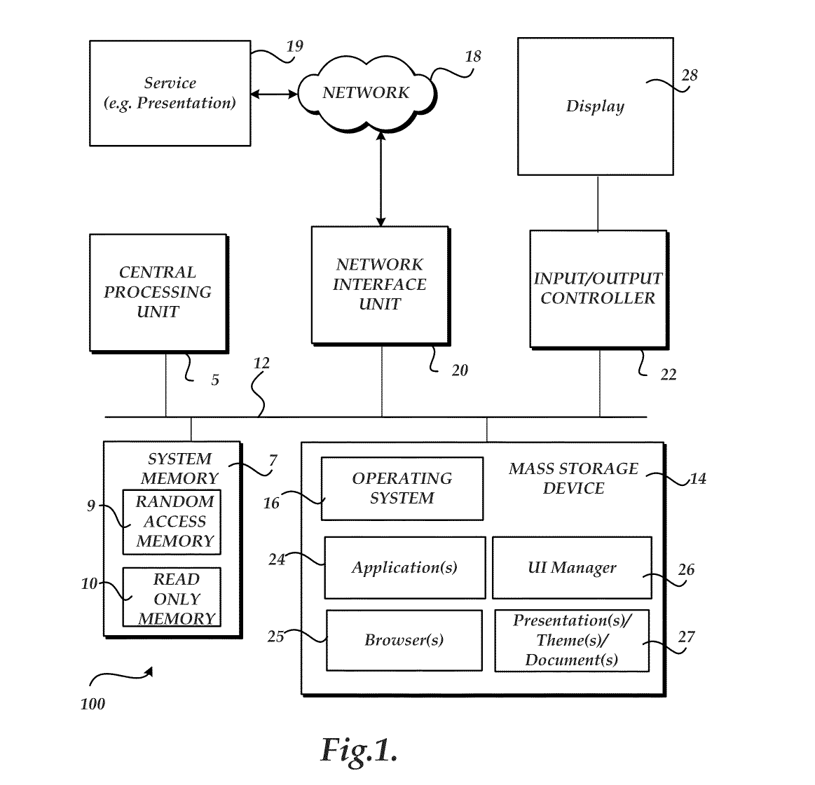

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a server computing device, a desktop computing device, a mobile computing device (e.g. smartphone, notebook, tablet . . . ) and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, presentation(s)/theme(s)/document(s) 27, and other program modules, such as Web browser 25, and UI manager 26, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, such as a touch input device. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display 28. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, may be integrated with other components of the computer 100 on the single integrated circuit (chip).

As mentioned briefly above, a number of program modules and data files may be stored in the mass storage device 14 and RAM 9 of the computer 100, including an operating system 16 suitable for controlling the operation of a networked computer, such as the WINDOWS SERVER®, WINDOWS 7® operating systems from MICROSOFT CORPORATION of Redmond, Wash.

The mass storage device 14 and RAM 9 may also store one or more program modules. In particular, the mass storage device 14 and the RAM 9 may store one or more applications 24, such as a UI manager 26, productivity applications (e.g. a presentation application such MICROSOFT POWERPOINT), and may store one or more Web browsers 25. The Web browser 25 is operative to request, receive, render, and provide interactivity with electronic content, such as Web pages, videos, documents, and the like. According to an embodiment, the Web browser comprises the INTERNET EXPLORER Web browser application program from MICROSOFT CORPORATION.

UI manager 26 may be on a client device and/or on a server device (e.g. within service 19). When UI manager 26 is on a client device it is configured to use icons generated on a server to display a GUI, such as within browser 25. When UI manager 26 is on a server, it is configured to generate icons and metadata for use on the client GUI. UI manager 26 may be configured as an application/process and/or as part of a cloud based multi-tenant service that provides resources (e.g. services, data . . . ) to different tenants (e.g. MICROSOFT OFFICE 365, MICROSOFT WEB APPS, MICROSOFT SHAREPOINT ONLINE). Generally, UI manager 26 is configured to generate icons on a server for use on a client GUI. The server may generate icons that contain graphical effects that cannot be rendered on the client (such as in a browser). Icons (e.g. bitmaps, PNGs, . . . ) that may be used in the client GUI are created by the server that when displayed show visual representations relating to a theme for the document (e.g. presentation). The icons may contain advanced effects (e.g. shadows, gradients, reflections, glows, 3D perspectives, and the like). The icons may be rendered automatically (e.g. during initial processing of the presentation, when the theme of the presentation changes) and/or upon demand. The icons are grouped by the server before sending the icons to the client. Information about the individual icons, such as the layout or style each represents, how/when to display the icon within the client GUI, as well as each icon's position in the group, is saved as XML metadata. This metadata is sent from the server to the client. The client (e.g. browser 25) obtains the image groups and displays them in GUI elements such as galleries, buttons, and dialogs. The client also obtains the metadata corresponding to the icons. Using the metadata, the client decomposes the group into individual icons and incorporates them into the GUI. Additional details regarding the operation of UI manager 26 will be provided below.

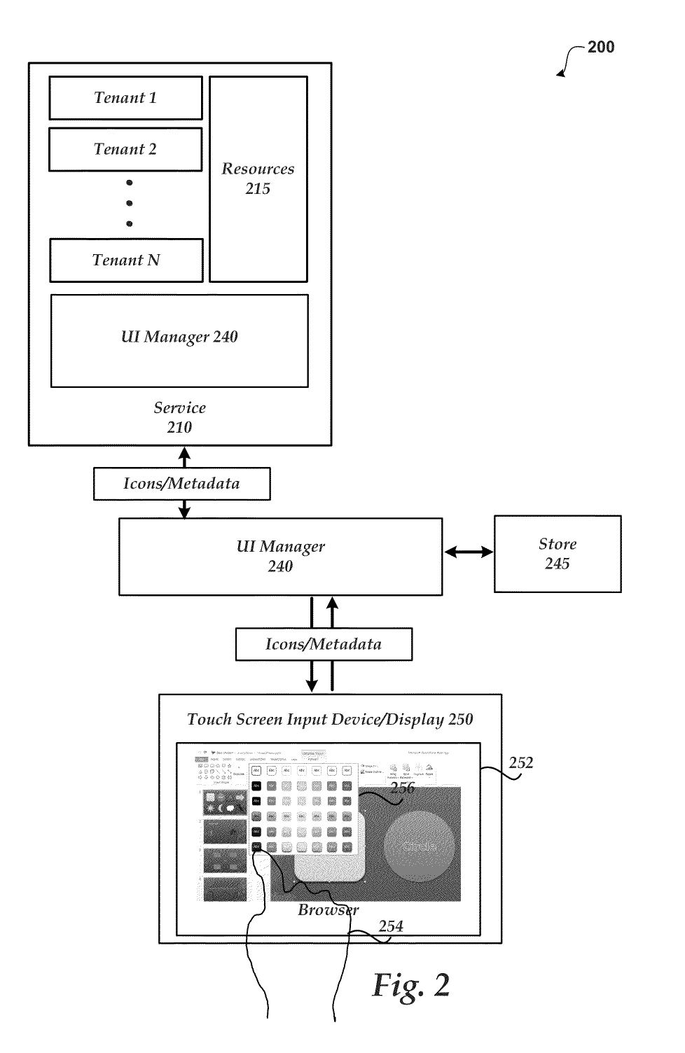

FIG. 2 illustrates an exemplary system for using server-side generated icons within a client GUI. As illustrated, system 200 includes service application 210, UI manager 240, store 245 and touch screen input device/display 250. As illustrated, service 210 is a cloud based and/or enterprise based service that is configured to provide productivity services (e.g. MICROSOFT OFFICE 365, MICROSOFT WEB APPS, MICROSOFT POWERPOINT, MICROSOFT WORD, MICROSOFT SHAREPOINT, MICROSOFT ONENOTE, MICROSOFT EXCEL). Functionality of one or more of the services/applications provided by service 210 may also be configured as a client based application. For example, a client device may include a presentation application and the service 210 may provide the functionality of the presentation application. Although system 200 shows a productivity service, other services/applications may be configured to use server-side generated icons for GUI display on a client device.

As illustrated, service 210 is a multi-tenant service that provides resources 215 and services to any number of tenants (e.g. Tenants 1-N). According to an embodiment, multi-tenant service 210 is a cloud based service that provides resources/services 215 to tenants subscribed to the service and maintains each tenant's data separately and protected from other tenant data.

System 200 as illustrated comprises a touch screen input device/display 250 that detects when a touch input has been received (e.g. a finger touching or nearly teaching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

As illustrated, touch screen input device/display 250 shows an exemplary GUI display 252 that uses icons 256 generated by service 210. UI manager 240 is configured to receive input from a user (e.g. using touch-sensitive input device 250 and/or keyboard input (e.g. a physical keyboard and/or SIP)). For example, UI manager 240 may receive touch input 254 that is associated with a GUI 252.

The UI manager 240 may be stored at one or more locations and may be accessed from one or more different locations. For example, UI manager may be stored in a cloud-based service and/or locally on a client device. The UI elements displayed on the browser are generated by a server (e.g. a server within service 210).

UI manager 240 examines the content/document/application being accessed to determine a theme associated with the document. Themes comprise theme colors, theme fonts, and/or theme effects that apply to a document, including text and data. Themes may be pre-defined and/or custom themes may be created. Generally, themes specify how effects are applied to your charts, SmartArt graphics, shapes, pictures, tables, WORDART, and text. By selecting a different theme, a user can quickly change the look of a document. A theme may include various effects such as style levels of line, fill, and special effects, such as shadow and three-dimensional (3-D) effects. Changing the theme associated with the document also changes icons used within the GUI used to interact with the document. A user may use the GUI to view/interact/make edits to a presentation, document, spreadsheet, and the like in a web browser.

Icons used in GUI 256 are created by a server (e.g. associated with service 210) and reflect the determine theme that is associated with a document. The icons used in GUI 256 may contain advanced graphical effects (e.g. shadows, gradients, reflections, glows, 3D perspectives, and the like) that may not be able to be generated by the client. The icons may be rendered automatically (e.g. during initial processing of a theme for a document, in response to an action) and/or upon demand. The icons are grouped by the server and information about the individual icons, such as the layout and/or style each icon represents, how/when to display the icon, as well as its position in the group, is saved as metadata. This metadata is included with the grouping of icons that is provided by the server to the client. The client receives the grouped icons and corresponding metadata and accesses the icons to create a display of GUI elements such as galleries, buttons, and dialogs.

A client may connect to the service using many different types of devices that are connected to the Internet (e.g. personal computing device, mobile computing device, tablet, phone, and the like). According to an embodiment, users may share and collaborate on documents with others, making simultaneous edits to documents in real time with great document fidelity and consistent formatting even when team members are working on different computing devices and/or computing devices with different software installed (e.g. so a PC with a different version of software installed, Apple computing device, slate device . . . ). The GUI for the web client is created such that the user has a similar experience as to working with a desktop application.

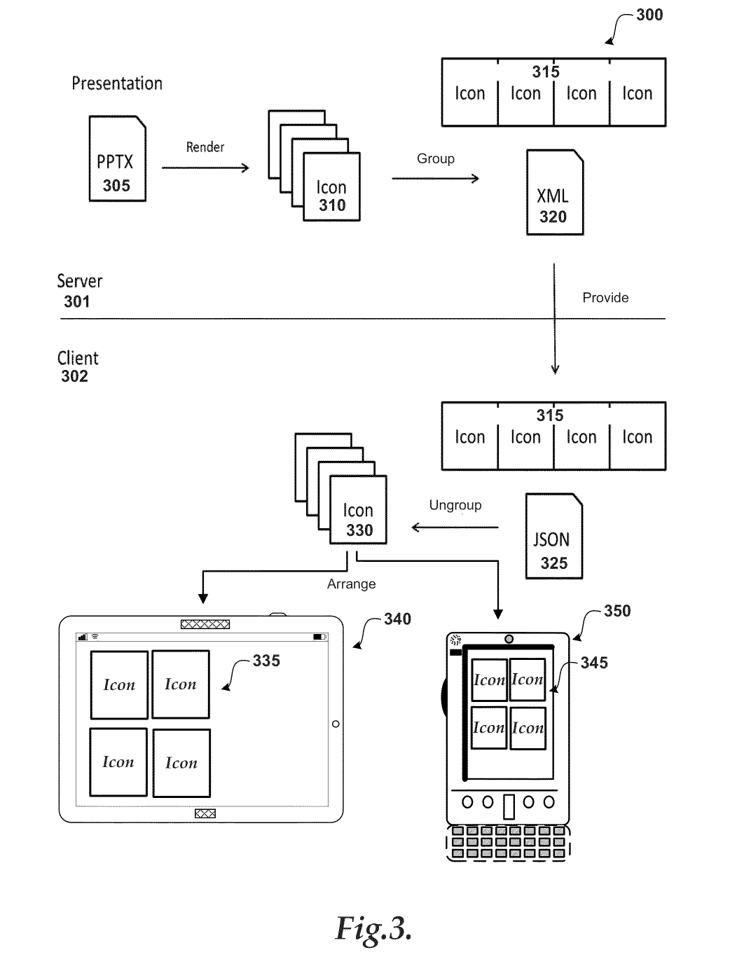

FIG. 3 shows a system using server-side processing for generating icons displayed on a client GUI. As illustrated, system 300 includes presentation 305, server generated icons 310, grouped icons 315, XML 320, JSON 325, ungrouped icons 330 and arranged icons 335 and 345 for display on tablet 340 and mobile device 350.

While a presentation document 305 relating to a presentation application (e.g. MICROSOFT POWERPOINT) is shown, other documents and applications may be used (e.g. spreadsheet, word-processing, graphics, note, messaging, document collaboration, database, and the like).

Initially a user accesses a document (e.g. document 305) on server 310 from client 302 to view/interact with. The document is parsed to determine the theme information (e.g. fonts, colors, effects, styles) for the document.

After determining the theme information, icons 310 are generated/rendered by server 310. The icons generated by the server may include icons that are not immediately used by the client in the display of the GUI on the client. For example, a current display may use one set of icons based on a theme whereas another display of the GUI uses a second set of icons generated by server 310. The icons generated by the server may include richer graphical elements that may not be supported by the application (e.g. browser) that the user is using to display the client GUI. The icons for the client GUI may change in response to a different theme. For example, one theme may include a first set of style user interface elements that show different formatting options as compared to another theme. Some of the generated icons show the user how content appears according to the determined theme.

Once the icons 310 are generated, the icons are grouped. Server 201 groups the icons into one or more groups such that each generated icon is not individually sent to the client. Instead, the generated icons may be included within a single image and/or grouped according to some other criteria (e.g. type of control icon is used for). According to an embodiment, the icons are placed within a single image. The icons in the image may be divided based on UI element(s) to which they apply. For example, one division of icons may apply to a first UI gallery, whereas another division of icons may apply to a second UI element within the client display.

Metadata is created by the server that provides information about the icons included within the grouping. According to an embodiment, the metadata is stored as XML/JSON (JavaScript Object Notation). The metadata comprises a location of each icon within the grouping. The metadata may also include other information, such as a type of the icon and when/how to display each of the icons.

The grouped icons and related metadata are provided from server 301 to client 302.

After receiving the grouped icons and metadata, client 302 may use an XML/JSON parser to understand the definitions that have been applied to those icons. Client 302 ungroups the icons and arranges the icons for display. As illustrated, the icons are arranged for a GUI display on a tablet device 340 and a mobile device 350. As discussed, the icons are displayable on a variety of different devices.

One or more of the icons for the client GUI may be regenerated by the server. For example, when a user changes the theme of the presentation, the icons that are affected are dynamically re-rendered such that any UI that needs to be updated reflects the theme change. In this way, the user is able to see content and GUI that reflects the latest theme.

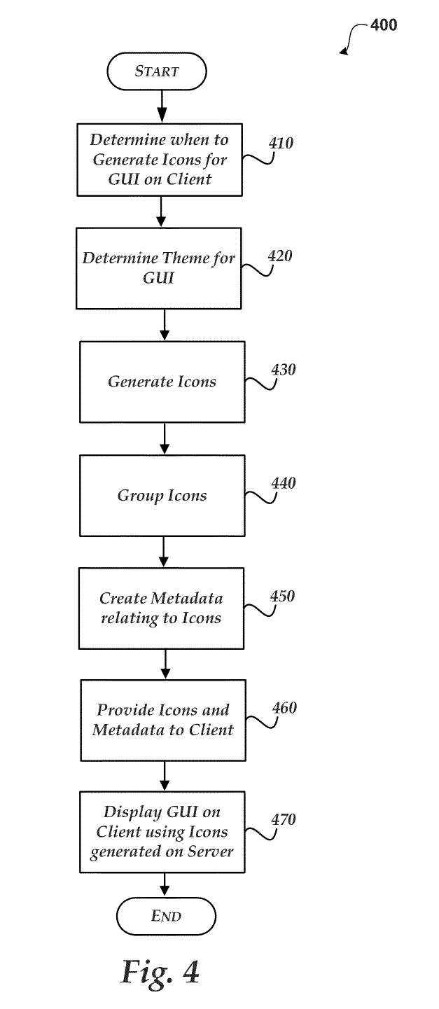

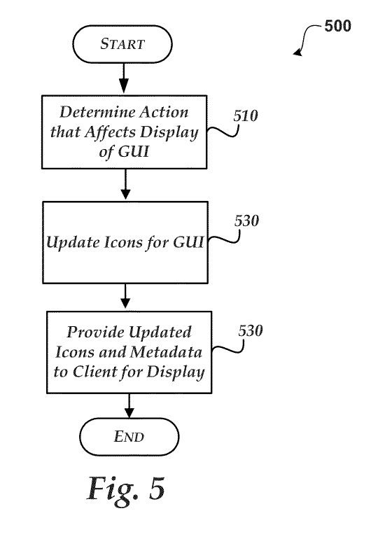

FIGS. 4-5 show an illustrative process for dynamically generating icons and metadata for client GUI elements. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 4 shows a process for dynamically generating icons and metadata on a server for client GUI elements.

After a start operation, the process flows to operation 410 where a determination is made as to when icons should be generated for a GUI that is to be displayed on a client. The GUI may interact with different applications/documents. For example, the GUI may be a web based GUI used to access a web based service (e.g. presentation application, word-processing application, spreadsheet application, document collaboration application, and the like.). According to an embodiment, the client GUI including server generated icons is displayed within a browser. The GUI may be alternatively/additionally displayed within a client based application.

Moving to operation 420, a theme for the icons of the GUI is determined The theme may define different characteristics used for displaying the UI and/or content (e.g. colors, fonts, styles, effects). Many different themes may be defined and associated with a same presentation/document. For example, one user may use a first theme to display document X, whereas another user may select a second theme to display document X. A user may change themes. Each theme change affects a generation of icons for use in the client GUI.

Flowing to operation 430, the icons for the GUI based on the determined theme are generated. According to an embodiment, the icons are static images (e.g. PNGs) that are used by the client to display the client GUI. For example, the icons may be displayed on top of user interface controls, build controls in JavaScript, and the like.

Transitioning to operation 440, the icons are grouped by the server. According to an embodiment, the icons are placed within a single picture. More than one picture may be used to store the icons. For example, a picture may be included for each type of icon generated (e.g. a picture for button icons, a picture for gallery icons, a picture for menu icons, a picture for each type of gallery, . . . ).

Moving to operation 450, metadata relating to the grouped icons is created. According to an embodiment, the metadata is specified as XML and comprises location information within the file for each of the icons and may include information relating to where/when the icon is to be displayed by the client in the GUI.

Flowing to operation 460, the grouped icons and metadata are provided to the client.

Transitioning to operation 470, the GUI on the client is displayed using at least a portion of the icons dynamically generated on the server.

The process then moves to an end operation and returns to processing other actions.

FIG. 5 illustrates a process for updating a GUI using dynamically generated icons and metadata.

After a start operation, the process 500 flows to operation 510, where an action is determined that affects a display of the GUI on the client. The action may be a user action and/or an action generated by the application. For example, a user may select a different theme, change a characteristic of a theme, select a menu option, and the like.

Moving to operation 520, the server dynamically generates icons to update the GUI display.

Flowing to operation 530, the newly generated icons are grouped and provided to the client with metadata for display in the client GUI.

The process then moves to an end operation and returns to processing other actions.

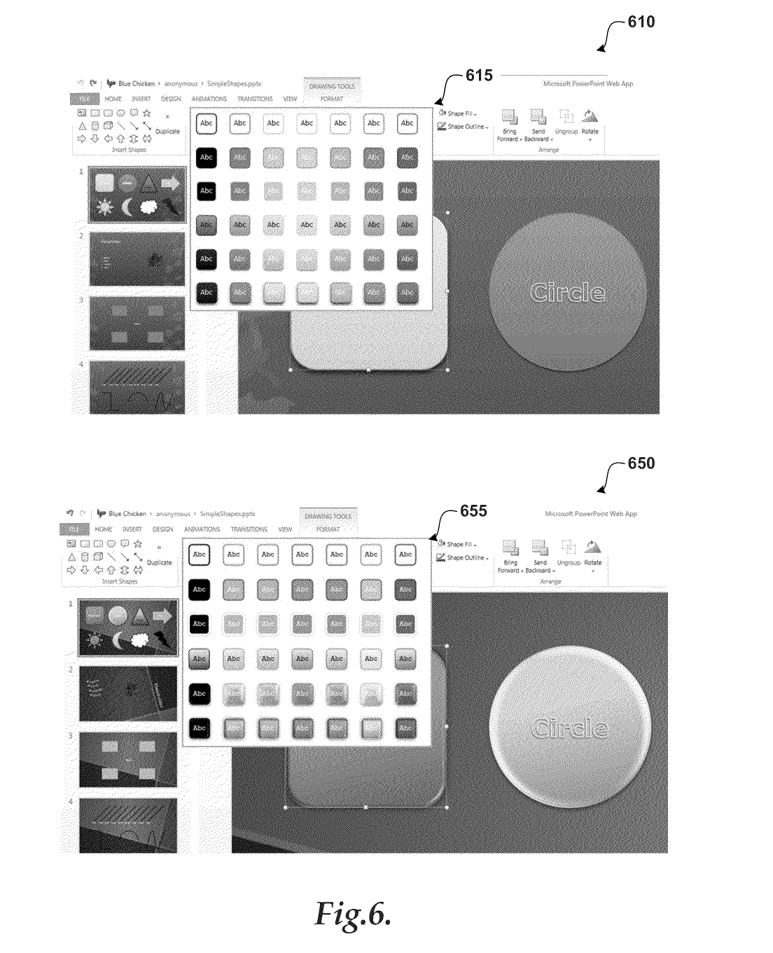

FIG. 6 shows exemplary displays of a presentation that shows a gallery UI on a client display using icons generated on a server for a first theme and a second theme.

Display 610 shows a presentation that follows a first theme. The icons shown in gallery UI 615 are generated on a server. Display 650 shows the presentation in response to a selection of a different theme than the theme shown in display 610. The icons shown in gallery UI 655 are generated on the server in response to the theme change. As can be seen, the presentation and the icons in the gallery UI not only use different colors and styles, the icons and presentation also have different effects applied to some elements. For example, the icons near the bottom of UI 655 shows a three dimensional effect. All/some of the icons of the client GUI may be dynamically generated by the server.

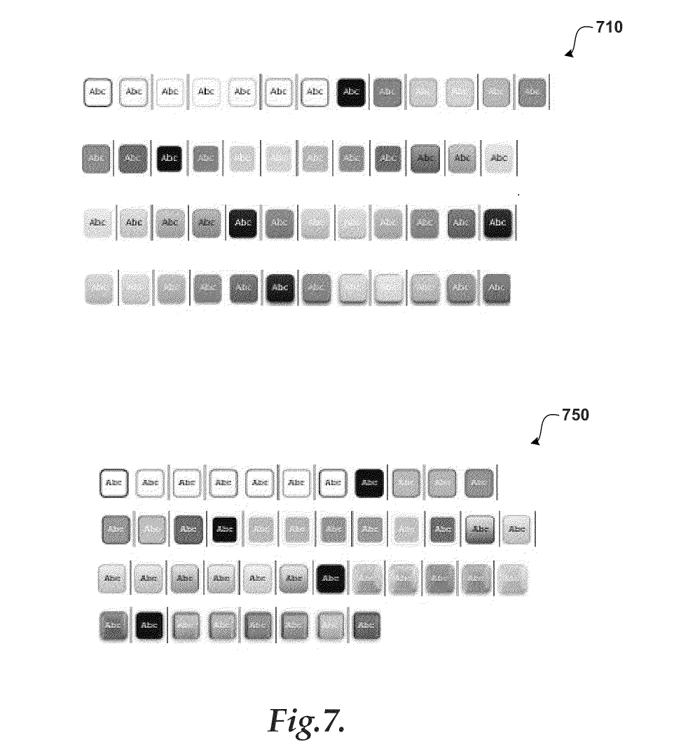

FIG. 7 shows exemplary icons groupings created on a server for a first theme and a second theme.

Icon grouping 710 shows the icons that are placed within the gallery UI 615 in FIG. 6. Icon grouping 750 shows the icons that are placed within the gallery UI 655 in FIG. 6. According to an embodiment, all of the icons for the GUI are placed within a single file in a single row. The icons have been split into four rows for purposes of showing all of the icons. The icons may be arranged in many different ways. For example, the may be arranged in a single row, rows and columns, a column for each separate GUI associated with an application, and the like.

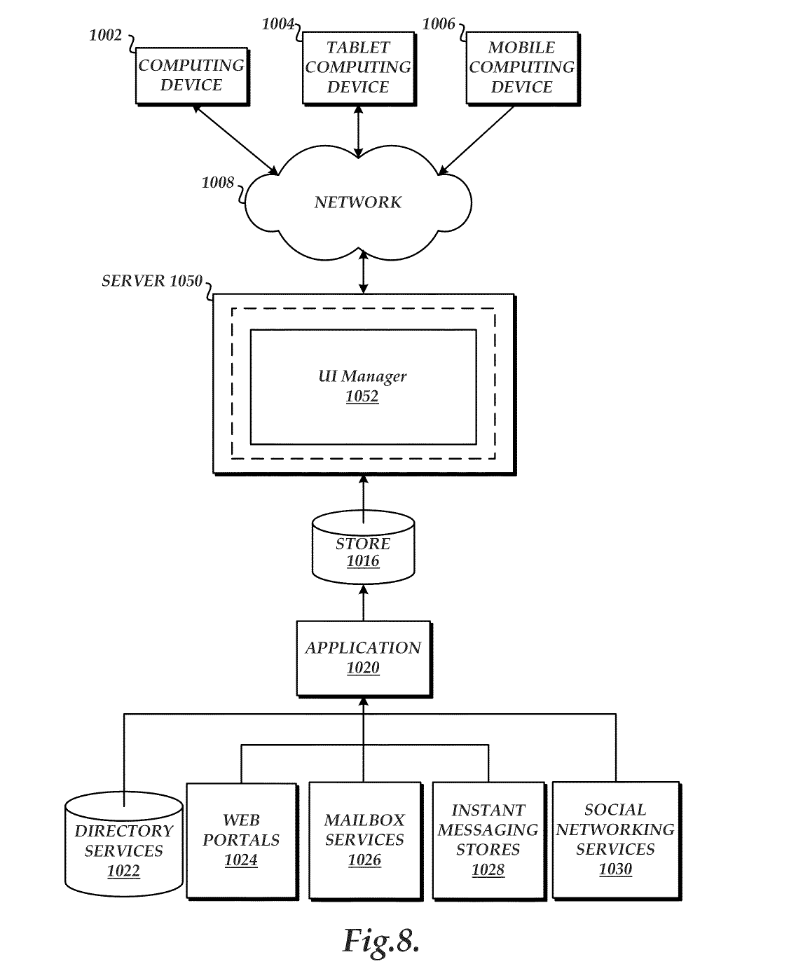

FIG. 8 illustrates a system architecture for dynamically generating icons on a server for a graphical user interface on a client, as described herein. Content used by the application and the UI manager 1052 may be stored at different locations. For example, application 1020 may use/store data using directory services 1022, web portals 1024, mailbox services 1026, instant messaging stores 1028 and social networking sites 1030. The application 1052 may use any of these types of systems or the like. A server 1050 may provide dynamically generated icons and metadata for application 1020 (e.g. a browser) to use in a client GUI. As one example, server 1050 may be a web server providing icons and related metadata relating to a GUI for a presentation application over the web. Server 1050 may provide the icons and metadata over the web to clients through a network 1008. Server 1050 may also comprise an application program (e.g. a presentation application). Examples of clients that may use dynamically generated icons from a server include computing device 1002, which may include any general purpose personal computer, a tablet computing device 1004 and/or mobile computing device 1006 which may include smart phones. Any of these devices may obtain content from the store 1016.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for dynamically generating icons on a server for use in a graphical user interface (GUI) displayed on a client, comprising:
determining when to generate icons for use on the GUI displayed on the client;
determining a theme for the GUI that defines a look and feel for the GUI;
generating icons on the server to be displayed on the GUI on the client; and
providing the icons generated on the server to the client for display on the GUI on the client.

2. The method of claim 1, wherein one or more of the icons include one or more of the following effects generated by the server: a shadow effect, a gradient effect, a reflection effect, a glow effect and a three-dimensional effect.

3. The method of claim 1, further comprising grouping the icons on the server before providing the icons generated on the server to the client.

4. The method of claim 3, further comprising creating metadata for the icons that provides information relating to a location of each of the grouped icons.

5. The method of claim 1, further comprising creating metadata for the icons that provides information used in displaying the icons on the GUI on the client.

6. The method of claim 1, wherein the icons are displayed over selectable GUI elements comprising galleries, buttons and dialogs.

7. The method of claim 1, further comprising determining when the theme changes and generating one or more new icons on the server used to update the GUI on the client.

8. The method of claim 1, further comprising dynamically generating the icons in response to one or more of: a change to the GUI, a change to a theme change and in response to a received selection.

9. The method of claim 1, wherein the icons are generated by the server for display within a browser.

10. A computer-readable medium having computer-executable instructions for dynamically generating icons on a server for use in a graphical user interface (GUI) displayed on a client, comprising:
determining when to generate icons for use on the GUI displayed on the client;
determining a theme for the GUI that defines a look and feel for the GUI;
generating icons on the server to be displayed on the GUI on the client; and
providing the icons generated on the server to the client for display on the GUI on the client.

11. The computer-readable medium of claim 10, wherein one or more of the icons include one or more of the following effects generated by the server: a shadow effect, a gradient effect, a reflection effect, a glow effect and a three-dimensional effect.

12. The computer-readable medium of claim 10, further comprising grouping the icons using a clustering algorithm executed on the server before providing the icons generated on the server to the client.

13. The computer-readable medium of claim 12, further comprising creating metadata for the icons that provides information relating to a location of each of the grouped icons.

14. The computer-readable medium of claim 13, further comprising creating metadata for the icons that provides information used in displaying the icons on the GUI on the client.

15. The computer-readable medium of claim 10, wherein the icons are displayed over selectable GUI elements in a browser comprising galleries, buttons and dialogs.

16. The computer-readable medium of claim 10, further comprising dynamically generating the icons in response to one or more of: a change to the GUI, a change to the theme and in response to a received selection.

17. A system for dynamically generating icons on a server for use in a graphical user interface (GUI) displayed on a client, comprising:
a display;
a network connection that is coupled to tenants of the multi-tenant service;
a processor and a computer-readable medium;
an operating environment stored on the computer-readable medium and executing on the processor; and
a process operating under the control of the operating environment and operative to perform actions, comprising:
determining when to generate icons for use on the GUI displayed on the client;
determining a theme for the GUI that defines a look and feel for the GUI;
generating icons on the server to be displayed on the GUI on the client;
grouping the icons on the server before providing the icons
generated on the server to the client;
creating metadata for the icons that provides information relating to a location of each of the grouped icons; and
providing the icons generated on the server to the client for display on the GUI on the client.

18. The system of claim 17, wherein one or more of the icons include one or more of the following effects generated by the server: a shadow effect, a gradient effect, a reflection effect, a glow effect and a three-dimensional effect.

19. The system of claim 17, wherein the metadata comprises information used in displaying the icons on the GUI on the client.

20. The system of claim 17, further comprising dynamically generating the icons in response to one or more of: a change to the GUI, a change to the theme and in response to a received selection.
